(19) United States
(12) Patent Application Publication
(10) Pub. No.: US 2024/0410216 A1
(43) Pub. Date: Dec. 12, 2024

(54) POWERED DOOR SYSTEM AND METHOD WITH NON-CONTACT OBSTACLE DETECTION CONTROL

(71) Applicant: MAGNA CLOSURES INC., Newmarket (CA)

(72) Inventors: Ryan HERMAN, Newmarket (CA); Dannie PARDILLO, Newmarket (CA)

(21) Appl. No.: 18/739,079

(22) Filed: Jun. 10, 2024

Related U.S. Application Data
(60) Provisional application No. 63/472,543, filed on Jun. 12, 2023.

(51) Int. Cl. E05F 15/43

(52) U.S. Cl. CPC E05F 15/43; E05F 2015/432; E05F 2015/763; E05Y 2900/531

(57) ABSTRACT

An object detection system and method of operation are provided. The system includes at least one non-contact sensor for detecting an object adjacent the motor vehicle within a first field of view. The system also includes a power actuator for moving the powered closure member. An electronic control unit is configured to detect the object adjacent the motor vehicle using the at least one non-contact sensor and control movement of the powered closure member accordingly. The electronic control unit is also configured to detect at least one non-powered closure member is not in a closed position. The electronic control unit adjusts the first field of view of the at least one non-contact sensor to a second field of view and operates the at least one non-contact sensor using the second field of view in response to detecting the at least one non-powered closure member is not in the closed position.

### CROSS-REFERENCE TO RELATED APPLICATION

This utility application claims the benefit of U.S. Provisional Application No. 63/472,543 filed Jun. 12, 2023. The entire disclosure of the above application is incorporated herein by reference.

### FIELD

The present disclosure relates generally to a non-contact obstacle and gesture detection system for a motor vehicle and methods of operating the non-contact obstacle and gesture detection system.

### BACKGROUND

This section provides background information related to the present disclosure which is not necessarily prior art.

Motor vehicles are increasingly being equipped with sensors that detect the environment and terrain surrounding the motor vehicle. For example, some vehicles include sensor systems that provide images of the terrain and/or other objects in the vicinity of the vehicle. Sensing systems have also been used to detect the presence and position of objects near the motor vehicle while the vehicle is moving. The signals and data generated by these sensor systems can be used by other systems of the motor vehicle to provide safety features such as vehicle control, collision avoidance, and parking assistance. Such sensing systems are generally used to assist the driver while he or she is driving the motor vehicle and/or to intervene in controlling the vehicle.

Additionally, closure members for vehicles (e.g. doors, lift gates, etc.) can be provided with powered actuation mechanisms capable of opening and/or closing the closure members. Typically, powered actuation systems include a power-operated device such as, for example, an electric motor and a rotary-to-linear conversion device that are operable for converting the rotary output of the electric motor into translational movement of an extensible member. Such power actuated operation can lead to issues with the closure members unintentionally striking surrounding objects or obstacles. For example, an object near the closure member may obstruct the opening or closing of the closure member and/or the closure member may be damaged if opened under power and strikes the obstacle. However, known sensing system or obstacle detection systems may not properly address potential situations involving obstacles. Furthermore, including powered actuation systems each with respective obstacle detection sensors on more than one closure member of a vehicle can lead to increased complexity and cost.

Thus, there is a need for improved obstacle and gesture detection systems that control movement of the closure member in response to detecting an object or gesture.

### SUMMARY

This section provides a general summary of the disclosure, and is not a comprehensive disclosure of its full scope or all of its features.

It is an object of the present disclosure to provide an object detection system for a motor vehicle with at least one powered closure member and at least one non-powered closure member. The system includes at least one non-contact sensor for detecting an object adjacent the motor vehicle within a first field of view. The system also includes at least one power actuator coupled to the at least one powered closure member for moving the at least one powered closure member. An electronic control unit is coupled to the at least one non-contact sensor and the at least one power actuator and is configured to detect the object adjacent the motor vehicle using the at least one non-contact sensor and control movement of the at least one powered closure member accordingly. The electronic control unit is also configured to detect the at least one non-powered closure member is not in a closed position. The electronic control unit adjusts the first field of view of the at least one non-contact sensor to a second field of view and operates the at least one non-contact sensor using the second field of view in response to detecting the at least one non-powered closure member is not in the closed position.

It is another object of the present disclosure to provide a method of detecting an object adjacent a motor vehicle with at least one powered closure member and at least one non-powered closure member using an object detection system. The method includes the step of detecting the object adjacent the motor vehicle within a first field of view using at least one non-contact sensor and controlling movement of the at least one powered closure member using at least one power actuator accordingly. The method proceeds by detecting the at least one non-powered closure member is not in a closed position. The method also includes the step of adjusting the first field of view of the at least one non-contact sensor to a second field of view and operating the at least one non-contact sensor using the second field of view in response to detecting the at least one non-powered closure member is not in the closed position.

It is another object of the present disclosure to provide an object detection system for a motor vehicle with a first closure member and a second closure member. The system includes at least one non-contact sensor for detecting an object within a field of view adjacent the first closure member and the second closure member. The system also includes a sensor for determining a position of the second closure member. The system further includes an electronic control unit coupled to the at least one non-contact sensor and the sensor and configured to modify the field of view in response to detecting, using the sensor, a change in position of the second closure member.

It is another object of the present disclosure to provide an object detection system for a motor vehicle with a first closure member and a second closure member, the system having at least one non-contact sensor for detecting an object within a field of view adjacent the first closure member and the second closure member, a sensor for determining a position of the second closure member, and an electronic control unit coupled to the at least one non-contact sensor and the sensor and configured to modify the field of view in response to detecting, using the sensor, a change in position of the second closure member, such that the modified field of view does not detect the second closure member using the at least one non-contact sensor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the following written description when considered in combination with the appended drawings, in which:

FIG. 1 is a perspective view of a motor vehicle equipped with a non-contact obstacle and gesture detection system capable of power door actuation according to aspects of the disclosure;

FIG. 2 is a diagrammatic view of the front passenger door shown in FIG. 1, with various components removed for clarity purposes only, in relation to a portion of the vehicle body and which is equipped with the non-contact obstacle and gesture detection system according to aspects of the disclosure;

FIG. 3 illustrates a plurality of non-contact obstacle or gesture sensors of the non-contact obstacle and detection system of FIGS. 1 and 2 on a mirror of the motor vehicle according to an aspects of the disclosure;

FIGS. 4 and 5 are diagrams of a top view of the motor vehicle including the object detection system and illustrating example locations of ones of the plurality of non-contact obstacle or gesture sensors and the field of view of one of the of the plurality of non-contact obstacle or gesture sensors according to an aspects of the disclosure;

FIG. 6 is a top view of the motor vehicle including the object detection system and illustrating another example location of at least one of the plurality of non-contact obstacle or gesture sensors and adjustment the first field of view of the at least one non-contact sensor to a second field of view in response to detecting the at least one non-powered closure member is not in the closed position according to an aspects of the disclosure;

FIGS. 7-12 are additional top views of the motor vehicle including the object detection system in various specific use cases according to an aspects of the disclosure; and

FIG. 13 illustrates steps of a method of detecting an object adjacent a motor vehicle with at least one powered closure member and at least one non-powered closure member using an object detection system according to an aspects of the disclosure.

Corresponding reference numerals indicate corresponding parts throughout the several views of the drawings.

### DETAILED DESCRIPTION

In the following description, details are set forth to provide an understanding of the present disclosure. In some instances, certain circuits, structures and techniques have not been described or shown in detail in order not to obscure the disclosure.

In general, the present disclosure relates to an obstacle and gesture detection system of the type well-suited for use in many applications. More specifically, a non-contact obstacle and gesture detection system for a motor vehicle and methods of operating the non-contact obstacle and gesture detection system are disclosed herein. The non-contact obstacle and gesture detection system of this disclosure will be described in conjunction with one or more example embodiments. However, the specific example embodiments disclosed are merely provided to describe the inventive concepts, features, advantages and objectives will sufficient clarity to permit those skilled in this art to understand and practice the disclosure.

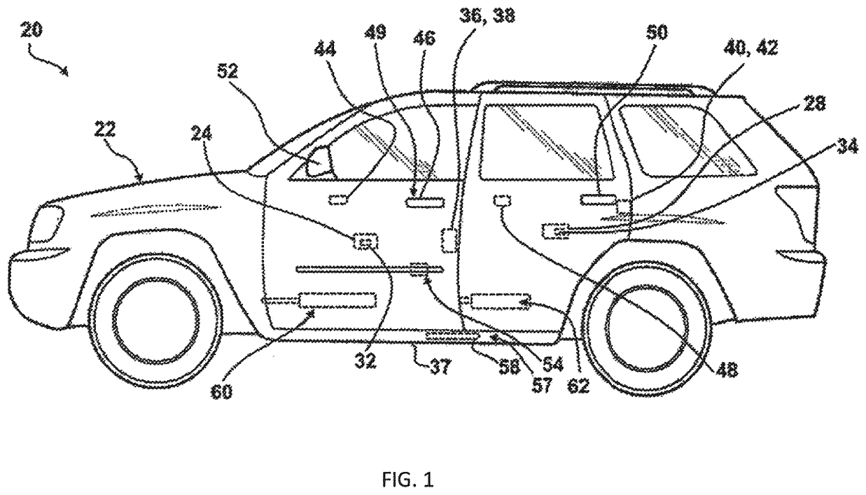

Referring to the Figures, wherein like numerals indicate corresponding parts throughout the several views, the non-contact obstacle and gesture detection system 20 for the motor vehicle 22 is shown. As best shown in FIG. 1, the non-contact obstacle and gesture detection system 20 includes a front door node 24 for a first closure member (e.g., front passenger door 26) and a rear door node 28 for a second closure member (e.g., rear passenger door 30).

The front door node 24 includes a first electronic control unit 32 that has a plurality of input-output terminals adapted to connect to a power source and to a vehicle bus (e.g., CAN or controller area network). The rear door node 28 includes a second electronic control unit 34 also adapted to connect to the power source and to the vehicle bus (e.g., CAN or controller area network). The first electronic control unit 32 and second electronic control unit 34 are each in communication with one another.

A first latch assembly 36 is in communication with the first electronic control unit 32 for latching the first closure member 26 relative to the motor vehicle 22 (e.g., to a vehicle body 37 of the motor vehicle 22). The system 20 also includes a first cinching actuator 38 coupled to the first latch assembly 36 for cinching the first closure member 26 to the vehicle body 37 of the motor vehicle 22. The system 20 also includes a second latch assembly 40 in communication with the second electronic control unit 34 for latching the second closure member 30 relative to the motor vehicle 22 and a second cinching actuator 42 is coupled to the second latch assembly 40 for cinching the second closure member 30 to the motor vehicle 22. For each latch assembly 36, 40, the cinch actuators 38, 42 may be included with or separate from the latch assemblies 36, 40.

At least one first handle switch (e.g., first inside and outside switches 44, 46 on the front passenger door 26) is coupled to the first electronic control unit 32 for detecting operation of a first handle of the first closure member 26. At least one second handle switch (e.g., second inside and outside switches 48, 50 on the rear passenger door 30) is also coupled to the second electronic control unit 34 for detecting operation of a second handle of the second closure member 30. Inside and outside switches 44, 46, 48, 50 on the front passenger door 26 and the rear passenger door 30 may be used to indicate that a user 21 is attempting to move the door 26, 30.

A plurality of non-contact sensors, also referred to as non-contact obstacle and gesture sensors 52, 54, 56, 58 are coupled to the first electronic control unit 32 for detecting the obstacle or gesture adjacent the motor vehicle 22. A first power actuator 60 is coupled to the first closure member 26 and to the first electronic control unit 32 for moving the first closure member 26 relative to the vehicle body 37. Similarly, a second power actuator 62 is coupled to the second closure member 30 and to the second electronic control unit 34 for moving the second closure member 30 relative to the vehicle body 37. Each of the first and second power actuators 60, 62 is configured to include an electric motor, a reduction geartrain, a slip clutch, and a drive mechanism, which together define a power assembly or first power actuator 60; however, it should be appreciated that various other power actuators 60, 62 may be used instead. Each of the first and second power actuators 60, 62 is configured to include a sensor for detecting the position (such as the absolute position) of the respective door to which the power actuator 60, 62 is configured to move. For example, sensor associated with the power actuator 60, 62 may be a hall-effect sensor arrangement in a configuration as is illustratively shown U.S. Pat. No. 11,713,609, the entire contents of which is incorporated herein by reference in its entirety. Other sensors for detecting the position of the closure panels may include for example a position sensor associated with the closure panel hinge.

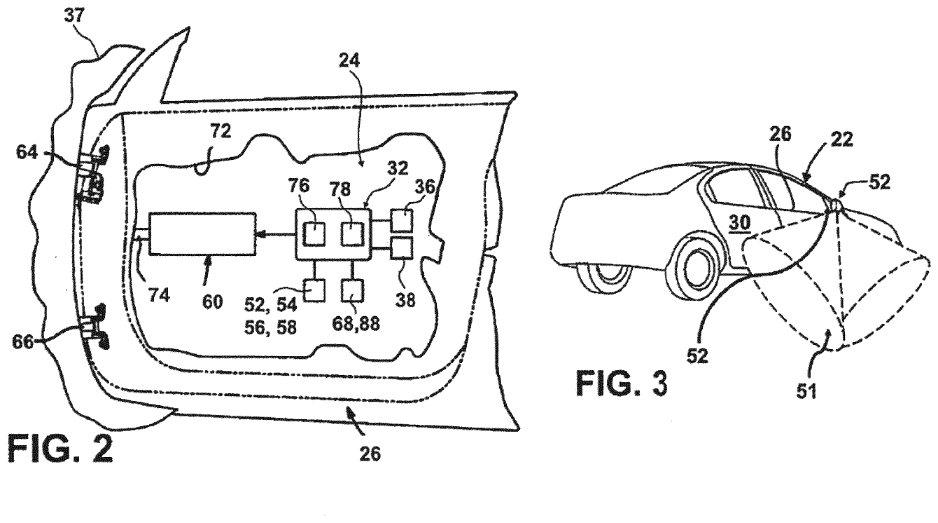

Referring to FIG. 2, the front passenger or vehicle door 26 is shown with the front door node 24 and is attached to the vehicle body 37 by an upper hinge 64 and a lower hinge 66. It should be appreciated that although only the first closure member 26 is shown, the second closure member 30 has a similar arrangement. At least one first Hall effect sensor 68 is coupled to the first electronic control unit 32 for monitoring a position and speed of the first closure member 26 during movement.

So, one or more first Hall-effect sensors 68 may be provided and positioned to send signals to the first electronic control unit 32 that are indicative of rotational movement of the electric motor and indicative of the rotational speed of the electric motor, for example, based on counting signals from the at least one Hall-effect sensor 68 detecting a target on a motor output shaft. In situations where the sensed motor speed is greater than a threshold speed and where a current sensor (not shown) registers a significant change in the current draw, the first electronic control unit 32 may determine that the user 21 is manually moving door 26 while the electric motor is also operating, thus moving vehicle door 26 between its open and closed positions. The first electronic control unit 32 may then send a signal to the electric motor to stop and may even disengage the slip clutch (if provided). Conversely, when the first electronic control unit 32 is in a power open or power close mode and the first Hall-effect sensors 68 indicate that a speed of the electric motor is less than a threshold speed (e.g., zero) and a current spike is registered, the first electronic control unit 32 may determine that an obstacle is in the way of vehicle door 26. If such an obstacle is detected, the system 20 may take any suitable action, such as sending a signal to turn off the electric motor. As such, the first electronic control unit 32 receives feedback from the Hall-effect sensors 68 to ensure that an obstacle contact has not occurred during movement of vehicle door 26 from the closed position to the open position, or vice versa. Similarly, although not shown in FIG. 2, at least one second Hall effect sensor 70 is coupled to the second electronic control unit 34 for monitoring a position and speed of the second closure member 30 during movement.

The first power actuator 60 for the first closure member 26 is shown mounted within an interior chamber 72 of door 26. Power swing door actuator 60 further includes a connector mechanism or extensible member 74 of the drive mechanism to connect to the vehicle body 37. So, the first electronic control unit 32 is in communication with the first power actuator 60 (e.g., the electric motor) for providing electric control signals thereto. The first and second electronic control units 32, 34 each can include a microprocessor 76 and a memory 78 having executable computer readable instructions stored thereon.

As is also schematically shown in FIG. 2, the first electronic control unit 32 can be in communication with the plurality of non-contact obstacle or gesture sensors 52, 54, 56, 58. The first electronic control unit 32 may also communicate with the first internal/external handle switch 44, 46 for receiving a request from a user 21 to open or close vehicle door 26. As shown, the first electronic control unit 32 can be packaged behind class-A surfaces (out of sight), for example, within door cavity 72 of door 26. However, it should be understood that the first electronic control unit 32 could instead be located in other areas such as, but not limited to within an outside mirror, door trim, rocker panel area, or may be provided within the first latch assembly 36.

The first electronic control unit 32 can, for example, receive a command signal from the internal/external handle switch 44, 46 to initiate an opening or closing of vehicle door 26. Upon receiving the command signal, first electronic control unit 32 can proceed to provide a signal to the electric motor (e.g., of first power actuator 60) in the form of a pulse width modulated voltage, for instance, (for speed control) to turn on the motor and initiate pivotal swinging movement of vehicle door 26. While providing the signal, first electronic control unit 32 also obtains feedback from the Hall-effect sensors 68 of the electric motor to ensure that contact with an obstacle has not occurred. If no obstacle is present, the motor can continue to generate a rotational force to actuate the spindle drive mechanism. Once vehicle door 26 is positioned at the desired location, the motor may be turned off and vehicle door 26 can be held at that location (i.e., door check).

The first electronic control unit 32 can also receive additional input from the plurality of non-contact obstacle or gesture sensors 52, 54, 56, 58 positioned on a portion of vehicle door 26, such as on a door mirror, or the like. The plurality of non-contact obstacle or gesture sensors 52, 54, 56, 58, for example, assess if an obstacle, such as another car, tree, or post, is near or in close proximity to vehicle door 26 or whether a user 21 is making a gesture near the vehicle door 26. A gesture may be for example a simple motion of the object, for example if the object is a person the gesture may include a motion of the hand such as a left to right swipe defining a simple gesture, or a more complex series of motions such as an intricate combination of gestures such as a hand moving up, then up, then down, then further down, then left, the right, and then in a circle. Other motions, such as a foot motion, a head motion, a motion of the entire body of the person such as a gait or walk or strut of the person may be detected. If such an obstacle or gesture is detected, the plurality of non-contact obstacle or gesture sensors 52, 54, 56, 58 will send a signal to first electronic control unit 32, and first electronic control unit 32 will proceed to control the electric motor (e.g., to stop movement of vehicle door 26, and thus prevent vehicle door 26 from hitting the obstacle).

FIG. 3 illustrates an example location of the plurality of non-contact obstacle or gesture sensors 52, 54, 56, 58 (e.g., radar sensors). Illustrative examples of radar sensors are shown and described in US Patent Application No. 2019/0128040A1 titled “Multifunction radar based detection system for a vehicle liftgate”, the entire contents of which are incorporated herein by reference in its entirety. Specifically, FIG. 3 illustrates a specific packaging location and detection zones of the one of the plurality of non-contact obstacle or gesture sensors 52, 54, 56, 58. Detection zone(s) 53 which may include one detection zone, or at least two detection zones may be limited to a two dimensional area, or be a three dimensional volume adjacent the motor vehicle 22. An outside mirror sensor 52 is disposed on the underside of an outside mirror of the vehicle 22 with the detection zone(s) 53 shown. The detection zone 53 can be projected backward to provide detection coverage to the rear door 28, as well. The detection zone 53 also protects the front door 26 during the power open cycle or may be used to detect one or more gestures.

The one of the plurality of non-contact obstacle or gesture sensors 52, 54, 56, 58 can also include at least one outwardly facing sensor 54, for example an inner trim sensor 54 disposed along a lower inner edge of the front door 26 inside the motor vehicle 22. Outwardly facing sensor 54 may also be provided in a door handle 49 or other location for providing an outwardly facing field of view. In more detail, the at least one inner trim sensor 54 is used to detect objects in the path of the closing door 26 (e.g., the at least one inner trim sensor 54 can be off while the door 26 is opening in an arc defined by its pivotal coupling to the vehicle body 37). The at least one inner trim sensor 54 can also be used to detect objects in the path of closing door 26, such as a knee. The one of the plurality of non-contact obstacle or gesture sensors 52, 54, 56, 58 can also include at least shut face sensor 56 disposed along a shut face of the door 26.

The plurality of non-contact obstacle or gesture sensors 52, 54, 56, 58 can also include a rocker panel sensor 58 disposed in a rocker panel of the vehicle 22 (e.g., under the front door 26). The rocker panel sensor 58 disposed on or inside the rocker panel 57 can be used to detect objects (e.g., the curb) in the path of the front door 26 while it is opening or while the front door 26 is closing (e.g., a leg). The plurality of non-contact obstacle or gesture sensors 52, 54, 56, 58 can each include a 77 gigahertz transceiver with an azimuth field of view of 140 degrees within a sealed housing. Such sensors 52, 54, 56, 58 are configured for detection of static objects (e.g., poles, vehicles, walls, curbs, etc.). The plurality of non-contact obstacle or gesture sensors 52, 54, 56, 58 are also configured for detection of slower moving dynamic objects (e.g., pedestrians). The plurality of non-contact obstacle or gesture sensors 52, 54, 56, 58 have illustrative operating parameters including −40° to +85° Celsius operation, 9 to 16 Volt operation, minimum detection range of 2 cm, maximum detection range of 15 meters, range resolution of 4 cm. Nevertheless, alternative sensors 52, 54, 56, 58, sensing technology, and arrangements of the plurality of non-contact obstacle or gesture sensors 52, 54, 56, 58 are contemplated.

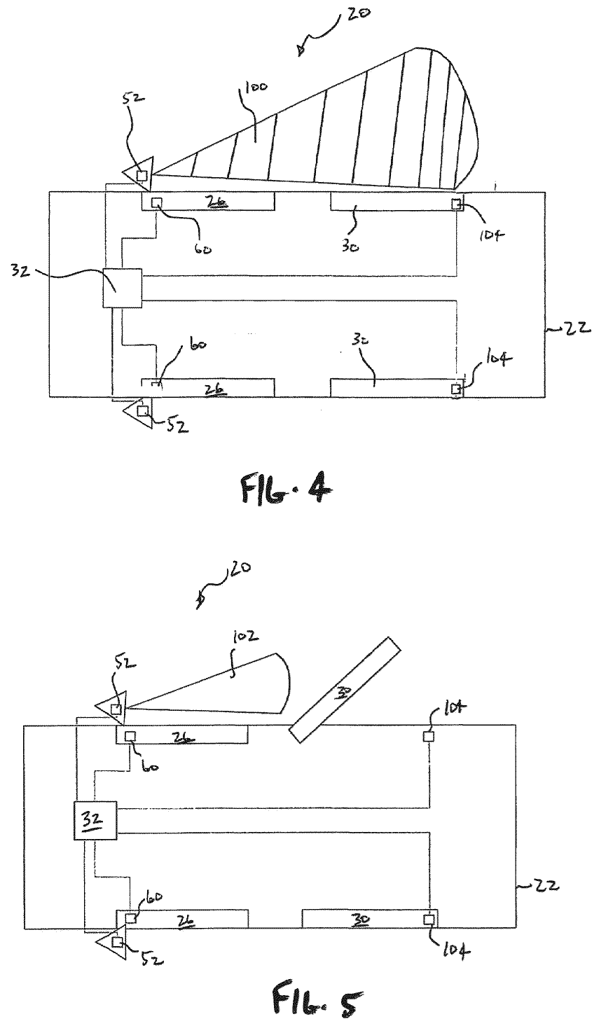

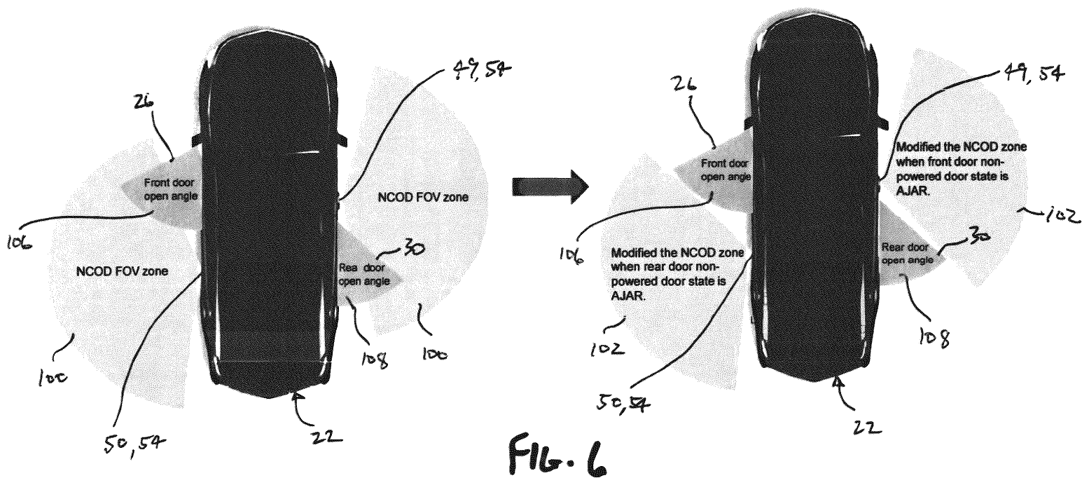

FIGS. 4 and 5 are diagrams of a top view of the motor vehicle 22 including the obstacle or object detection system 20 and illustrating example locations of ones of the plurality of non-contact obstacle or gesture sensors 52, 54, 56, 58 and the field of view of one of the of the plurality of non-contact obstacle or gesture sensors 52, 54, 56, 58. As shown, the motor vehicle 22 includes at least one powered closure member 26, 30 (e.g., front door 26) and at least one non-powered closure member 26, 30 (e.g., rear passenger door 30). As above, the system 20 also includes at least one non-contact sensor 52, 54, 56, 58 for detecting an object or obstacle adjacent the motor vehicle 22 within a first field of view 100. The system 20 also includes at least one power actuator 60 coupled to the at least one powered closure member 26, 30 for moving the at least one powered closure member 26, 30. An electronic control unit 32 is coupled to the at least one non-contact sensor 52, 54, 56, 58 and the at least one power actuator 60 and is configured to detect the object adjacent the motor vehicle 22 using the at least one non-contact sensor 52, 54, 56, 58 and control movement of the at least one powered closure member 26, 30 accordingly. If the first field of view 100 of the at least one non-contact sensor 52, 54, 56, 58 is utilized when the at least one non-powered closure member 26, 30 is open, for example, the object detection system 20 will detect the at least one non-powered closure member 26, 30 as an obstacle. So, it is desirable for the at least one non-powered closure member 26, 30 to somehow be disregarded during powered movement of the at least one powered closure member 26, 30 by the at least one power actuator 60. Thus, referring specifically to FIG. 5, the electronic control unit 32 is also configured to detect the at least one non-powered closure member 26, 30 is not in a closed position (i.e., ajar). The electronic control unit 32 adjusts or modifies the first field of view 100 of the at least one non-contact sensor 52, 54, 56, 58 to a second field of view 102 and operates the at least one non-contact sensor 52, 54, 56, 58 using the second field of view 102 in response to detecting the at least one non-powered closure member 26, 30 is not in the closed position. The field of view 100 may be decreased for example if the at least one non-contact sensor 52, 54, 56, 58 is located on the front closure panel and the rear closure panel is opening, or the field of view 100 may be increase for example if the at least one non-contact sensor 52, 54, 56, 58 is located on the front closure panel and the front closure panel is opening. The field of view 100 may be continually modified based a continually changing position of a closure member such that the field of view 102 does not overlap or detect the closure member as the closure member is moving between the open and closed position. In another possible configuration, the field of view 100 may be changed discretely from a first field of view 100 (e.g. maximum) to a second field of view 102 when a closure member has been detected to have moved away from a close position such that the field of view 102 does not change while the closure member is moving between the fully opened and fully closed position such that the field of view 102 does not overlap or detect the closure member when the closure member is in the fully opened position.

According to an aspect, the second field of view 102 is reduced compared to the first field of view 100. So, the electronic control unit 32 can ignore part of the field of view of the at least one non-contact sensor 52, 54, 56, 58 when an adjacent or partner door (e.g., rear passenger door 30 when the at least one powered closure member 26, 30 is the front door 26) is detected to move from its closed position. Since the adjacent door (e.g., rear passenger door 30) may be non-powered, an absolute position of that door may not be known, only if it is open, as described in more detail below. For example, the electronic control unit 32 can ignore part of the field of view by disregarding data received from the at least one non-contact sensor 52, 54, 56, 58 associated with part of the field of view that the at least one powered closure may be moving or positioned within. The electronic control unit 32 can disregard data associated with part of the field of view based on angular data received by electronic control unit 32, such as for example when a FMCW radar sensor outputting angular data associated with a detected obstacle is employed, and/or based on distance data received electronic control unit 32, such as for example when a FMCW radar sensor outputting radial distance data associated with a detected obstacle is employed. As a result, the field of view may be modified such that the closure member does not overlap with the modified field of view such that the closure member as an obstacle would be trigger a false obstacle detection. In other words, while the closure panel may occupy an angular zone of the field of view as detected by the at least one non-contact sensor 52, 54, 56, 58, the electronic control unit 32 may receive data indicating the detection of an obstacle, but ignore or not act on such detection data knowing the obstacle is the closure panel. In one possible configuration the field of view may be continuously modified during the detected movement of the closure panel. In another possible configuration, the electronic control unit 32 may be configured to modify the field of view from a first field of view when the position of the second closure member is detected to be in the closed position to a second field of view when the position of the second closure member is detected not to be in the closed position, wherein the second field is not modified after the second closure member is detected not to be in the closed position. In other words, the modified field of view is selected to ensure that a fully opened closure member is not detected by the at least one non-contact sensor 52, 54, 56, 58 in any position of the door closure member. Such a configuration may be employed for example when the moving closure member is not configured with an absolute position sensor, but rather with a door ajar sensor (e.g. provided in a door latch) sensor configured only to detect when the door is not in a closed position.

Continuing to refer to FIGS. 4 and 5 and according to aspects of the disclosure, the object detection system 20 can further include an ajar switch 104 for the at least one non-powered closure member 26, 30. The ajar switch 104 is in communication with the electronic control unit 32 and is configured to determine whether the at least one non-powered closure member 26, 30 is in the closed position and output an ajar signal to the electronic control unit 32 in response to the at least one non-powered closure member 26, 30 not being in the closed position. While not shown in FIGS. 4 and 5, it should be appreciated that the ajar switch 104 may additionally associated with the at least one powered closure member 26, 30 (e.g., front door 26).

Thus, the adjustment of the first field of view 100 of the at least one non-contact sensor 52, 54, 56, 58 to the second field of view 102 and operating the at least one non-contact sensor 52, 54, 56, 58 using the second field of view 102 as described herein may involve the ajar signal being sent from the non-powered partner door 26, 30 to the powered door controller (e.g., electronic control unit 32). If the electronic control unit 32 knows the non-powered door 26, 30 is not in the home or closed position, the algorithm of the electronic control unit 32 can be modified to ignore targets in the swing path of the non-powered door 26, 30. This will effectively limit the field of view of the powered door 26, 30. The risk of limiting the field of view is mitigated by the fact that the non-powered door 26, 30 will physically stop an obstacle or object from contacting the powered door 26, 30 in the event there are additional obstacles in the area. If the non-powered door 26, 30 is open, it will be struck first by the object or obstacle. The responsibility for the non-powered door 26, 30 against obstacle contact resides with the operator 21, as in normal mechanical or non-powered doors 26, 30. Depending on how the algorithm of the electronic control unit 32 is executed or software architecture, the electronic control unit 32 may require an additional bus (e.g., CAN) message for the ajar signal to trigger the change of field of view or otherwise ignoring the targets or objects within a swing path of the non-powered or partner door 26, 30, for example.

The adjustment of the first field of view 100 of the at least one non-contact sensor 52, 54, 56, 58 to the second field of view 102 and operating the at least one non-contact sensor 52, 54, 56, 58 using the second field of view 102 described herein can be implemented on vehicles 22 where either only the front pair or rear pair of doors are powered (see e.g., FIGS. 4 and 5). Also, this adjustment can be implemented on vehicles 22 with forward swing, rear swing (suicide) doors in any position.

According to another aspect and as previously discussed, the at least one non-contact sensor 52, 54, 56, 58 may be an outside mirror sensor 52 disposed on an outside mirror of the motor vehicle 22. The first field of view 100 and the second field of view 102 of the outside mirror sensor 52 extend outwardly from the outside mirror sensor 52 and fan out increasingly wider toward a rear of the motor vehicle 22.

So, on four door vehicles (e.g., motor vehicle 22) with four powered doors 26, 30, it is possible for the position of the doors 26, 30 away from the closed position to be known or communicated to the electronic control unit 32. It is expected that the at least one non-contact sensor 52, 54, 56, 58 will detect the adjacent or partner door (i.e., door 26, 30 on the same side of the vehicle 22) when the partner door is ajar and/or in motion. In this case the object identified by the at least one non-contact sensor 52, 54, 56, 58 can be judged against known position information of other doors 26, 30 on the vehicle 22, A data-based decision regarding the status of the obstacle (false or not) can be made.

Referring back to FIGS. 4 and 5, for example, on four door vehicles 22 where only two doors 26 are equipped with power door technology, it is only possible to know the position of the power door 26 at all times, The non-powered doors 30 can represent obstacles at any position away from the home or closed position when they are detected by the at least one non-contact sensor 52, 54, 56, 58. No additional data is present for the at least one non-contact sensor 52, 54, 56, 58 to distinguish if the non-powered door 30 is an obstacle or is intended to be in that location. The non-powered door 30 should not represent a contact obstacle criteria to the at least one non-contact sensor 52, 54, 56, 58 as it is likely impossible for the doors 26, 30 to actually collide during motion in most vehicles 22. Radar technologies can see a wider field of view than current ultrasonic sensors, so this problem may become more prevalent on newer generation systems.

FIG. 6 is a top view of the motor vehicle 22 including the object detection system 20 and illustrating another example location of at least one of the plurality of non-contact obstacle or gesture sensors 52, 54, 56, 58 and adjustment the first field of view 100 of the at least one non-contact sensor 52, 54, 56, 58 to a second field of view 102 in response to detecting the at least one non-powered closure member 26, 30 is not in the closed position. As shown and as previously discussed, the at least one non-contact sensor 52, 54, 56, 58 may be an outwardly facing sensor 54 disposed in a door handle 49, 50 of the motor vehicle 22 (e.g., the door handle 49 of the front door 26 and/or the door handle 50 of the rear passenger door 30). The first field of view 100 and the second field of view 102 of the outwardly facing sensor 54 extend outwardly from the outwardly facing sensor 54 and fan out increasingly wider away from the motor vehicle 22. However, as discussed above, the second field of view 102 is smaller than the first field of view 100 and does not include areas in which the at least one non-powered closure member 26, 30 moves when ajar. A front door open path 106 of the front door 26 and a rear door open path 108 of the rear passenger door 30 are shown.

Although, in FIGS. 4 and 5, for example, both front doors 26 are shown as being powered and moveable by the power actuator 60 and both rear passenger doors 30 are shown as being non-powered, it should be understood that any of the doors 26, 30 may be powered and operated in a non-powered state or may be non-powered other than as shown. Thus, the at least one non-powered closure member 26, 30 may also be one of the at least one powered closure members 26, 30 that is operated in a non-powered state.

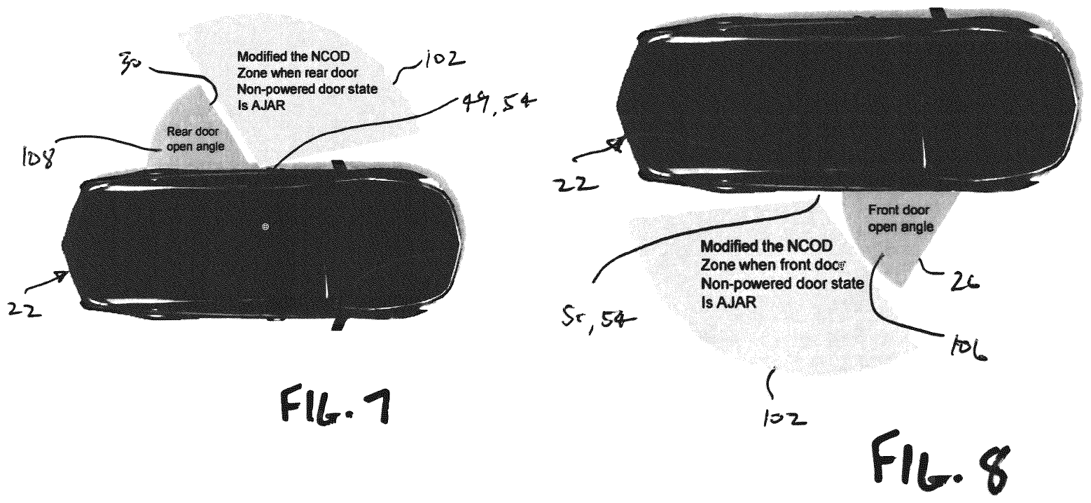

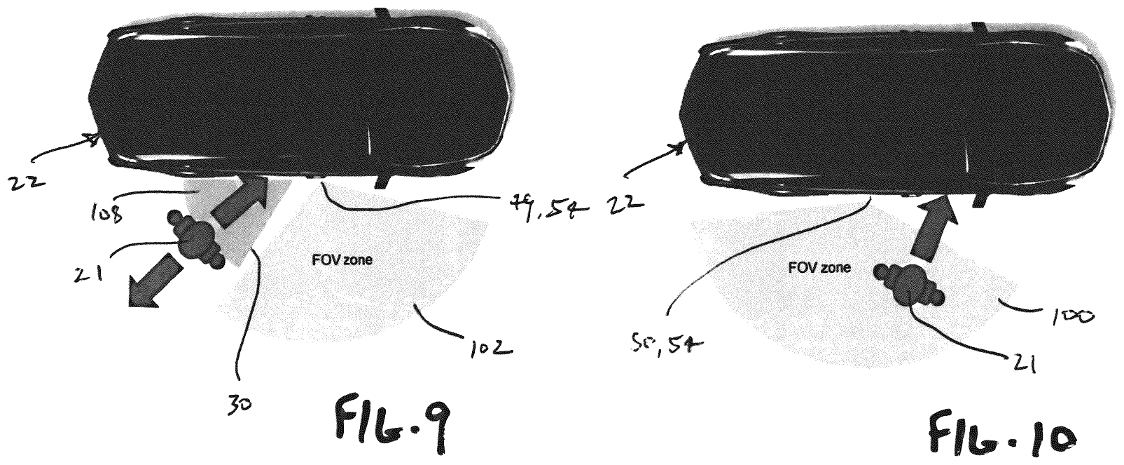

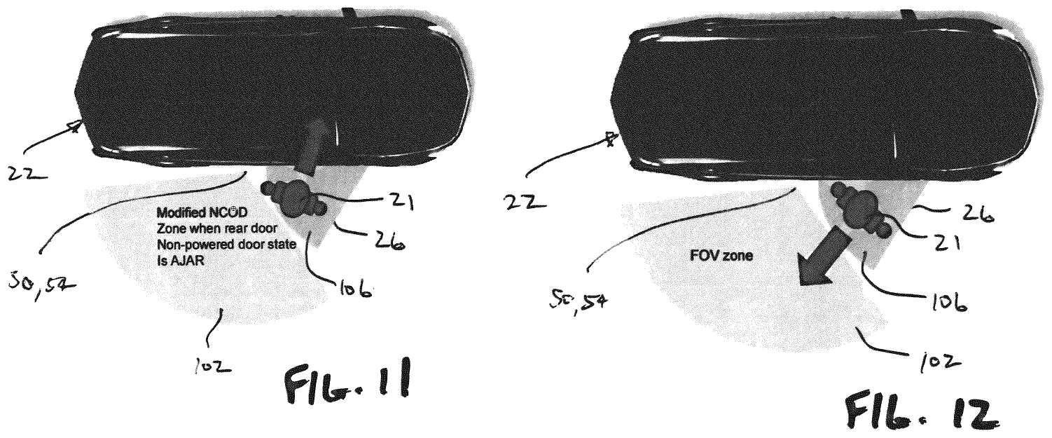

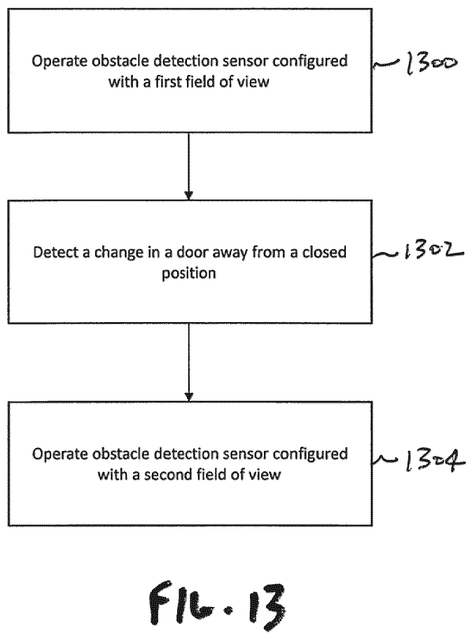

FIGS. 7-12 are additional top views of the motor vehicle 22 including the object detection system 20 in various specific use cases. Specifically, FIG. 7 shows an adjusted or modified field of view 102 of the outwardly facing sensor 54 on the front door 26 when the rear passenger door 30 is in a non-powered state and is not closed (i.e., ajar). Wide side mirrors of the vehicle or other structures protruding from the motor vehicle 22 can also be neglected in the NCOD zone or field of view 102. FIG. 8 shows an adjusted or modified field of view 102 of the outwardly facing sensor 54 on the rear passenger door 30 when the front door 26 is in a non-powered state and is ajar. The modified field of view 102 is reduced by excluding an angular zone 101 of the field of view for consideration of detectable obstacles since the front door 26 as a known obstacle is occupying the angular zone of exclusion 101. The electronic control unit may in one possible configuration receive data from the at least one non-contact sensor 52, 54, 56, 58 indicating that the door 26 is detected in this angular zone 101, yet ignore this data for determining if an obstacle is detected in the field of view 102. When front door 26 is closed, angular zone 101 is included in the field of view for consideration of detectable obstacles. FIG. 9 shows the adjusted or modified field of view 102 of the outwardly facing sensor 54 on the front door 26 when the rear passenger door 30 is in a non-powered state and is ajar and an operator 21 is entering or exiting the motor vehicle 22 through the rear passenger door 30 (e.g., in the rear door open path 108). As shown, the operator 21 is entering or exiting the rear passenger door 30 is blocked by the rear passenger door 30 from impacting automatic motion of the front door 26 by the at least one power actuator 60. Therefore, the adjusted field of view 102 of the outwardly facing sensor 54 on the front door 26 does not increase the risk of obstacle contact. FIG. 10 shows the field of view 100 of the outwardly facing sensor 54 on the rear passenger door 30 when the operator 21 is entering or exiting the motor vehicle 22 through the front door 26. As shown, the operator 21 is entering or exiting the front door 26 is not blocked by the rear passenger door 30 and would impact automatic motion of the front door 26 by the at least one power actuator 60. In this case, operation of the rear passenger door 30 needs to take into account the operator 21 approaching the motor vehicle 22 prior to opening the front door 26. No field of view modification is necessary when the ajar signal from the front door 26 is not present. FIG. 11 shows the adjusted of modified field of view 102 of the outwardly facing sensor 54 on the rear passenger door 30 when the operator 21 is entering the motor vehicle 22 through the front door 26. As shown, the operator 21 is entering the front door 26 is not blocked by the rear passenger door 30 and would impact automatic motion of the rear passenger door 30 by the at least one power actuator 60. In this case, operation of the rear passenger door 30 needs to take into account the operator 21 approaching the motor vehicle 22 prior to opening the rear passenger door 30. So, field of view modification of the outwardly facing sensor 54 on the rear passenger door 30 is necessary when the ajar signal from the front door 26 is present. FIG. 12 shows the adjusted of modified field of view 102 of the outwardly facing sensor 54 on the rear passenger door 30 when the operator 21 is entering or exiting the motor vehicle 22 through the front door 26. As shown, the operator 21 is entering or exiting the front door 26 is not blocked by the rear passenger door 30 and would impact automatic motion of the rear passenger door 30 by the at least one power actuator 60. In this case, the field of view of the outwardly facing sensor 54 on the rear passenger door 30 needs to be modified in order to reduce false obstacle detection. If the motion of the operator 21 intrudes on the reduced field of view the outwardly facing sensor 54 on the rear passenger door 30, powered motion of the rear passenger door 30 shall be modified to avoid contact with the obstacle (e.g., the operator 21).

FIG. 13 illustrates steps of a method of detecting an object adjacent a motor vehicle 22 with at least one powered closure member 26, 30 and at least one non-powered closure member 26, 30 using an object detection system 20. The method includes the step of 1300 detecting the object adjacent the motor vehicle 22 within a first field of view 100 using at least one non-contact sensor 52, 54, 56, 58 and controlling movement of the at least one powered closure member 26, 30 using at least one power actuator 60 accordingly. The method continues with the step of 1302 detecting the at least one non-powered closure member 26, 30 is not in a closed position. The method also includes the step of 1304 adjusting the first field of view 100 of the at least one non-contact sensor 52, 54, 56, 58 to a second field of view 102 and operating the at least one non-contact sensor 52, 54, 56, 58 using the second field of view 102 in response to detecting the at least one non-powered closure member 26, 30 is not in the closed position.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An object detection system for a motor vehicle with a first closure member and a second closure member, each of the first closure member having closed position and an open position relative to a motor vehicle body, the system comprising:
at least one non-contact sensor for detecting an object adjacent the first closure member and the second closure member within a first field of view;
wherein the first field of view is adjusted to ignore detection of one of the first closure member and the second closure member in response to one of the first closure member and the second closure member moving from the closed position to the open position.

2. The object detection system as set forth in claim 1, wherein the first closure member is a powered closure member and the second closure member is a non-powered closure member, the object detection system further comprising:
a power actuator coupled to the first closure member for moving the powered closure member; and
an electronic control unit coupled to the at least one non-contact sensor and the power actuator and configured to:
detect the object adjacent the motor vehicle using the at least one non-contact sensor and control movement of the powered closure member accordingly,
detect the non-powered closure member is not in a closed position, and
adjust the first field of view of the at least one non-contact sensor to a second field of view and operate the non-contact sensor using the second field of view in response to detecting the non-powered closure member is not in the closed position.

3. The object detection system as set forth in claim 1, further including an ajar switch for the non-powered closure member in communication with the electronic control unit and configured to determine whether the non-powered closure member is in the closed position and output an ajar signal to the electronic control unit in response to the non-powered closure member not being in the closed position.

4. The object detection system as set forth in claim 1, wherein the at least one non-contact sensor is an outside mirror sensor disposed on an outside mirror of the motor vehicle and the first field of view and the second field of view extend outwardly from the outside mirror sensor and fan out increasingly wider toward a rear of the motor vehicle.

5. The object detection system as set forth in claim 1, wherein the at least one non-contact sensor is an outwardly facing sensor disposed in a door handle of the motor vehicle and the first field of view and the second field of view extend outwardly from the outwardly facing sensor and fan out increasingly wider away from the motor vehicle.

6. An object detection system for a motor vehicle with a first closure member and a second closure member, the system comprising:
at least one non-contact sensor for detecting an object within a field of view adjacent the first closure member and the second closure member;
a sensor for determining a position of the second closure member; and
an electronic control unit coupled to the at least one non-contact sensor and the sensor and configured to modify the field of view in response to detecting, using the sensor, a change in position of the second closure member such that the modified field of view does not detect the second closure member using the at least one non-contact sensor.

7. An object detection system for a motor vehicle with a first closure member and a second closure member, the system comprising:
at least one non-contact sensor for detecting an object within a field of view adjacent the first closure member and the second closure member;
a sensor for determining a position of the second closure member; and
an electronic control unit coupled to the at least one non-contact sensor and the sensor and configured to modify the field of view in response to detecting, using the sensor, a change in position of the second closure member.

8. The object detection system of claim 7, further comprising a first power actuator coupled to the first closure panel for moving the first closure member, and a second power actuator coupled to the second closure panel for moving the second closure panel, wherein the first power actuator comprises another sensor coupled to the electronic control unit for detecting the position of the first closure member and the second power actuator comprises the sensor for detecting the position of the second closure member, wherein an electronic control is configured to modify the field of view in response to detecting, using the sensor and the another sensor, a change in position of the first closure member and the second closure member.

9. The object detection system of claim 8, wherein the electronic control is configured to increase and decrease the field of view in response to detecting a change in position of the first closure member and the second closure member.

10. The object detection system of claim 7, wherein the electronic control unit is configured to modify the field of view by ignoring obstacles detected in part of the field of view.

11. The object detection system of claim 10, wherein the modified field of view does not overlap with the position of the first closure member and the second closure member.

12. The object detection system of claim 7, wherein at least one non-contact sensor is a radar sensor.

13. The object detection system of claim 7, wherein the electronic control unit is configured to modify the field of view by ignoring obstacles detected in angular zones of the field of view.

14. The object detection system of claim 7, wherein the electronic control unit is configured to modify the field of view by ignoring obstacles detected beyond radial distances of the field of view.

15. The object detection system of claim 7, wherein the electronic control unit is configured to continually modify the field of view in response to detecting a continually changing position of the second closure member.

16. The object detection system of claim 7, wherein the electronic control unit is configured to modify the field of view from a first field of view when the position of the second closure member is detected to be in the closed position to a second field of view when the position of the second closure member is detected not to be in the closed position, wherein the second field is not modified after the second closure member is detected not to be in the closed position.

17. The object detection system of claim 16, wherein the second field of view does not overlap with the second closure member in the fully opened position.

18. The object detection system of claim 16, wherein the second closure member is a non-powered closure member.

19. The object detection system of claim 18, wherein the second closure member is a non-powered closure member.

20. The object detection system of claim 18, wherein the sensor is a door ajar sensor.
